(19) United States
(12) Patent Application Publication
(10) Pub. No.: US 2023/0351296 A1
(43) Pub. Date: Nov. 2, 2023

(54) SYSTEMS AND METHODS FOR RISK VISUALIZATION

(71) Applicant: CRINDATA, LLC, Plano, TX (US)

(72) Inventors: James H. Freis, Washington, DC (US); Mark M. Stetler, Ormond Beach, FL (US)

(21) Appl. No.: 18/142,383

(22) Filed: May 2, 2023

Related U.S. Application Data
(60) Provisional application No. 63/337,534, filed on May 2, 2022.

(51) Int. Cl. G06Q 10/0635

(52) U.S. Cl. CPC G06Q 10/0635

(57) ABSTRACT

Systems and methods for risk visualization are disclosed. A risk evaluation platform obtains outsourcing relationship data for an outsourcing company, the outsourcing relationship data including (i) identification of one or more service provider entities that provide services that directly or indirectly affect the outsourcing company and (ii) identification of relevant outsourcing relationships of each of the one or more service provider entities; identifies areas of interest in the relationship data; and generates a visual representation of the relationship data, including flagging the areas of interest. The areas of interest can include identification of sub-contractors, concentrations of risk, and cross-jurisdictional relationships or entities.

### RELATED APPLICATION INFORMATION

This application claims priority under 35 U.S.C. § 119(e) to U.S. Provisional Application No. 63/337,534, entitled “Systems and Methods for Risk Visualization,” filed May 2, 2022. This application is also related to U.S. Provisional Application Nos. 63/337,527, entitled “Systems and Methods for Operational Risk Management,” filed May 2, 2022; 63/337,535, entitled “Communication System and Applications Thereof,” filed May 2, 2022, and 63/337,536, entitled “Systems and Methods for Reporting of Incidents,” filed May 2, 2022. All of the above applications are incorporated herein by reference as if set forth in full.

### BACKGROUND

### Field of the Invention

The embodiments described herein are generally directed to a risk management and communications platform, and more particularly to a software-as-a-service (SaaS) platform and data analytics for risk management related to outsourcing and reliance on third party service providers.

### Description of the Related Art

Faced with a trend towards greater outsourcing and reliance on third party service providers, including with respect to material or critical functions, there is a need for the outsourcing company to better understand operational risks and options to mitigate them, including in the context of incidents or service disruptions. In their development and delivery of products and services, companies increasingly rely on external third party service providers (TPSPs, or service providers). This is particularly true with respect to IT service providers, be they software providers or related to the infrastructure or cloud solutions that enable them. Additionally, a company may integrate and make available under its own brand name a service or component prepared by another company, in a process commonly referred to as “white labelling.”

There are many reasons why a company might choose to outsource to or rely upon a TPSP, taking into consideration aspects of comparative expertise and specialization, time and resources otherwise needed internally to develop all such services, and costs. A description as an outsourcing relationship generally may be used to denote that a company does not provide the service itself, but rather obtains it from a distinct legal entity generally under a contractual relationship, but also in the context of other relationships such as those among distinct but affiliated entities under a common ownership structure, e.g., when under a parent holding company, either the holding company itself or one subsidiary provides services to other affiliated entities under a common ownership or control structure, regardless of whether a formal contract or payment relationship exists. The decision to outsource nonetheless involves a tradeoff in terms of less control over TPSPs than a company would have over services provided entirely within the company. For certain services (e.g., IT products or software, or the communications connections or electricity sources needed to operate them), a company might not view it as an option that is economically or commercially feasible, or for regulated entities consistent with their licensed activities, to “insource” a service in a type of vertical integration rather than obtain such service from an external provider. There is not consistent use of terminology or characterization (e.g., outsourcing, reliance, white labelling) nor circumscribable means of informal or formal agreements or contracting that can be used to define or describe the plethora of types of relationships, or of the designation of the actors (e.g., outsourcer, outsourcing company/entity, counterpart, TPSP, service provider, subcontractor, fourth party) in such relationships, that can give rise to operational risk outside of an entity's direct control. Thus, the use of individual terms, for simplification herein often referring to a company outsourcing to a TPSP and applicable subcontractors, is not meant as a limiting factor, but rather to provide examples in illustrating the nature and application of the specific innovations described herein.

A further complexity in understanding and managing operational risk is that a company may outsource certain services, but also be a service provider to other entities. Moreover, a service provider might further sub-outsource or sub-contract services creating multi-layered risk relationships with parties that are unrelated (contractually, through common ownership or control, or otherwise) and often unknown to the party incurring the risk.

A failure or disruption of service provided by a TPSP can have an adverse effect upon the outsourcing company's services and fulfillment of the company's obligations towards its customers/users, which could result in a loss of revenue or reputation directly or indirectly; could make the services unavailable for a period of time or otherwise degrade the customer experience; or could result in a breach of contractual terms, or other legal or regulatory obligations. A company should understand the nature of such dependencies, and understand an analysis of its sensitivity to different level or severity of failure or disruption, including the duration before service is restored, if applicable. A company applying a risk-based approach might focus on the relationships for which it assesses have a higher degree of significance, materiality, or criticality (or analogous criteria chosen by such company) to the company's services or risks.

A company should attempt to mitigate the risks of its dependencies upon TPSPs through due diligence on counterparties and other entities in the counterparties' risk chain (subcontractors to the company) both before entering into relationships and generally refreshed from time to time such as annually, and through ongoing oversight and monitoring of TPSP relationships and performance.

There are numerous challenges in understanding, overseeing, and monitoring risks with respect to TPSPs, including in the context of transparency and access to information, among which the most formidable, and which the innovations of the invention help to address, are:
Lack of standardization—While many principles or indicia of risk are commonly understood, e.g., aspects of the corporate structure, ownership, licensing, reputation of a service provider; size, financial strength, insurance coverage; and operational controls and service history, there is no universal or even accepted unique or exclusive process or catalog of information and documentation requested from the outsourcer or made available by the service provider.
Differing risk tolerance—Moreover, distinct outsourcers may have different uses, risk tolerance, and related need for information with respect to a given service, even if such service is largely the same from the perspective of the provider.
Relative market strength—Even under a presumption that services and contractual agreements are negotiated, this does not mean that an outsourcer will have the ability to agree to all aspects that would be preferred as relevant to its outsourcing risk mitigation, in particular where the TPSP is attempting to offer a standardized service.
Temporal challenges—An outsourcer is primarily concerned with the reliability of its TPSP going forward into the future, and disruption in some services could have a “real-time” negative impact on a company. Under current practices, however, an outsourcer generally relies on historical information (e.g., review of a service provider's audited financial report for the prior year), which temporal delay is exacerbated by delays in receiving information from TPSPs, and because material reviews are conducted primarily on a periodic basis. For example, an annual review by an outsourcer of a TPSP implies that changes in risk relevant information are not considered until the next update cycle up to a year later. Thus, current review practices based on historical information are imperfect proxies for mitigating concerns of ongoing risk exposure, especially for time-sensitive outsourcing dependencies. In the event of a service disruption incident requiring prompt intervention, dated risk management relevant information might need to be rectified before attention can be turned to addressing the incident, thus further exacerbating damages from the incident.
Subcontractors/sub-outsourcers— TPSPs in turn may rely on other entities, sometimes referred to as “fourth parties” to deliver services. The outsourcer may have even less transparency as to such subcontractors, sub-outsourcers, or potential chain of underlying entities with which it might not have any contractual or other relationships.
Changing circumstances—Over time, the service relationship between an outsourcer and its TPSPs (including in light of subcontractors) may evolve, or circumstances change, leading to a need to update or agree changes to representations or contractual terms—e.g., evolution of the service offering, pricing adjustments due to inflation, change of subcontractor relationship; regulatory notification—which can pose challenges to deliver or confirm, especially when an acknowledgement or agreement of the counterpart is required. An absence of acknowledgement or express agreement can lead to ambiguity or lack of contractual enforceability.
Cross jurisdiction—Any of the foregoing elements can become more complicated in the context of an outsourcer and service provider (or subcontractors) operating in different jurisdictions and under different legal systems, which could affect expected practices or timeliness and enforceability of contractual provisions or exposure of the outsourcer such as to data loss or different regulatory requirements.

Even if an outsourcer were to understand these challenges, risk evaluation and mitigation efforts in any given TPSP relationship cannot necessarily eliminate risk. In this context, it should be understood that a 99% availability performance expectation includes up to 1% failure. The failure in performance by a TPSP, especially one providing critical services, often cannot be recovered by contractual damage payments (e.g., which under common commercial terms may be limited to the fee paid for the services, and which rarely provide for indirect damages such as reputational losses).

The overall challenge is even greater when faced with a multitude of outsourcings, where there is probability that one or more TPSPs will face disruption at any given time. This suggests the need for a structured rather than ad hoc approach to outsourcing oversight to be effective and efficient. Just as a type of cost-benefit analysis would have been made to outsource a service in the first place, the ongoing oversight and risk mitigation measures with respect to any given TPSP should not be so onerous as to outweigh the benefits.

Realization of the foregoing creates opportunities for specialization in the context of risk management. There are some products available in the market which attempt to address limited aspects of the foregoing problems. For example, vendor management software may seek to facilitate the ability of one company to organize underlying documentation and information relevant to its vendors; some risk scoring workflows and decision-making processes and algorithms may be offered in a digital format to relieve manual processes; some functions have been developed that seek to jointly gather documentation relevant to risk management, such as a vendor which maintains a central database of common vendors; or an industry grouping or association may seek to share information gathering, auditing, and/or verification processes.

Such services, however, primarily reflect long-established processes of an outsourcing company conducting due diligence and making risk decisions with respect to its TPSP. Moreover, existing services narrowly adopt approaches or workflows in individual jurisdictions.

### SUMMARY

Accordingly, systems, methods, and non-transitory computer-readable media are disclosed to a platform for risk analysis and visualization.

The embodiments described herein assist in operational risk management across a broad range of potential causes of failures and disruptions. For example, due to increasing attention to cybersecurity risks, there are various evolving offerings attempting to assess, mitigate, evaluate or report various aspects that may be caused by cybersecurity events or incidents. The embodiments are not narrowly limited to a single cause or class of causes like those commonly associated with cybersecurity, but rather risk management of the effects of an incident and in furtherance of business continuity and operational resilience. For example, the result of total unavailability of a system supported by an external TPSP would be the same for a company regardless of whether that disruption was caused by an intentionally malicious cybersecurity act, an unforeseen failure of the service through improper design or operation, or even a natural disaster. The embodiments described herein could be applied in all such circumstances, with additional further value by the data analytics applicable to different causes. Moreover, as distinct from analytical tool offerings which have a narrower focus on the root causes of an incident, the data analytics described herein provide more holistic overviews of risks from a range of possible incidents.

In an embodiment, a method of providing a risk overview for an outsourcing company comprising is disclosed. The method uses a hardware processor to: obtain outsourcing relationship data of the outsourcing company, the outsourcing relationship data including (i) identification of one or more service provider entities that provide services that directly or indirectly affect the outsourcing company and (ii) identification of relevant outsourcing relationships of each of the one or more service provider entities; identify one or more areas of interest in the relationship data; and generate a visual representation of the relationship data, including flagging the one or more areas of interest.

In one embodiment, a non-transitory computer-readable medium having instructions stored therein, wherein the instructions, when executed by a processor, cause the processor to: obtain outsourcing relationship data including identification relationships between two or more of a plurality of connected entities, wherein at least a portion of the relationships are multi-directionally validated; obtain a selection of at least one of (i) a type of risk evaluation, (ii) an entity of the plurality of connected entities, and (iii) an area of interest; and based on the selection, generate a visual representation of the outsourcing relationship data.

Any of the methods above may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a structured process to maintain a current and correct overview of outsourcing relationships, which in turn would enable incident notifications and reporting, according to an embodiment;

FIG. 4 illustrates a process of multi-directional validation from the perspective of an outsourcing company, using the example of a financial institution, according to an embodiment;

FIG. 5 illustrates a process of multi-directional validation from the perspective of a service provider, according to another embodiment;

FIG. 6 illustrates an example of the platform being used to communicate a service disruption, according to an embodiment; and

FIG. 7 illustrates a process of service disruption communication through regulatory reporting of an incident using the platform, according to an embodiment.

### DETAILED DESCRIPTION

The embodiments described herein are directed to systems, methods, and non-transitory computer-readable media for a platform for risk management that facilitates operational risk management through new processes, more efficient and effective shared solutions, and analysis across multiple data sources, to generate unique insights. While having broad applicability, the example embodiments described herein focus particularly on outsourcing by banks and other financial services providers due to the highly regulated environment in which they operate, including regulatory expectations that they focus on operational risk management in connection with outsourcings. But the embodiments described are by way of example and not for the purpose of limitation.

Some of the characteristics of the financial services industry that make it useful as an example and able to benefit strongly from the embodiments described herein are: the high degree of regulation, time sensitive aspects of the delivery of many financial services, the particular focus of that industry and regulatory oversight on risk mitigation, policy concerns in terms of negative externalities with respect to the failure of an individual institution or broader systemic risk, heavy reliance on outsourcing of services (with comparatively lesser dependence on supply chain of goods as compared, e.g., to physical manufacturing processes), specific focus on the subset of operational risk management, regulatory expectations and requirements with respect to service provider and counterpart due diligence, and evolving regulatory expectations and requirements for notification in the event of incidents such as disruptions including due to cybersecurity events.

Additionally, concentrations of financial institutions and their service provider participants, including the multitude of outsourcing relationships, accelerates the advantages provided by the embodiments described herein in terms of mutually reinforcing enrichment and validation, as well as more precise insights through the data analytics.

For the purposes of this application, “financial institution” is meant to be the broadest possible description of the provision of financial services to third parties, be they individuals or corporate entities. Examples include entities taking deposits and making loans commonly referred to as “banks” regardless of charter type; other financial services actors in the securities, commodities, and derivatives markets; insurance markets; payments, money transmission or other money services businesses; crypto and virtual asset service providers; exchanges or other platforms for coordinating buyers and sellers; and other forms of value intermediation for investment, speculation, or to enable customers to buy or sell other products or services. Financial institutions are generally subject to licensing and regulation regimes based on the nature of their products and services, or of their customer base, or a combination of the two categories. A background concept is that while a financial institution can outsource certain services, it cannot outsource the responsibility and the risk. To varying degrees, responsibility may come in the context of being a licensed or regulated financial service, which includes requirements or expectations of prudent risk management.

Analogous need for operational risk management in outsourcing, and thus a need for the innovations described herein, can also be found in other sectors. This need can analogously to financial services be subject to regulation, or in a company's efforts to mitigate risks of product compliance, such as where a branding company is ultimately responsible under contractual or tort liability for the quality and potential misfunctioning, errors or omissions including those which might be caused by a white labeling or other TPSP including subcontractor relationships. For example, the medical and pharmaceutical industries involve both significant regulation and also significant risk related to product compliance. One such situation occurs where the production of the medicines or component compounds is outsourced and subject to oversight of the outsourcing company. Even in industry sectors not as heavily subject to regulation, the systems and methods described herein add value as part of the good business proposition or could be something that an entity holds out to its customers such as in contractual representations, warranties, or guarantees as to as level of service or product functionality, while the entity manages the operational risks in connection with its outsourcing relationships.

The precision provided by the systems and methods described herein aids entities with respect to the specific legal entities (e.g., outsourcer, service provider, subcontractor) involved, and also helping customers meet specific legal and regulatory requirements as well as contractually agreed terms. Each of the components of corporate formation, contract and tort law, and specific licensing and regulatory requirements are associated with specific governmental jurisdictions, e.g., US Federal, State, foreign country, local, etc., and choice of law. That notwithstanding, many legal entities operate in a cross-border or multi jurisdictional space. This is particularly true with respect to IT or digital services that do not have the constraints of traditional “brick-and-mortar” supplier-to-retailer-to-customer physical interfaces that can be identified in connection with a jurisdiction.

A goal for operational risk management that applies to outsourcing is to have a holistic view across all relevant aspects—this also requires looking beyond jurisdictional borders. For example, in the regulated financial services industry, a financial group that has branches or subsidiaries licensed, operating, or serving customers in multiple jurisdictions may be subject to the range of different requirements in those jurisdictions, all of which must be taken into consideration for a holistic view of operational risk management. From the perspective of a TPSP, it might provide a digital service for which it is agnostic as to where the outsourcing company or its customers are located; some business models seek to provide essentially the same service on a global basis which would mean that a range of outsourcing risk management practices and regulations could apply to the TPSP's customer base. Existing products or services that may target limited aspects of the challenges of outsourcing risk management—to the extent they take into consideration a regulatory framework—narrowly adopt workflows or processes for a specific market or jurisdiction. The systems and methods described herein are specifically designed to provide common systems and methods to facilitate the ability of each of outsourcers and TPSPs to manage outsourcing risks across various jurisdictions through common principles and approaches and thus providing holistic operational risk management oversight, while additionally targeting specific needs of the identified applicable jurisdictions.

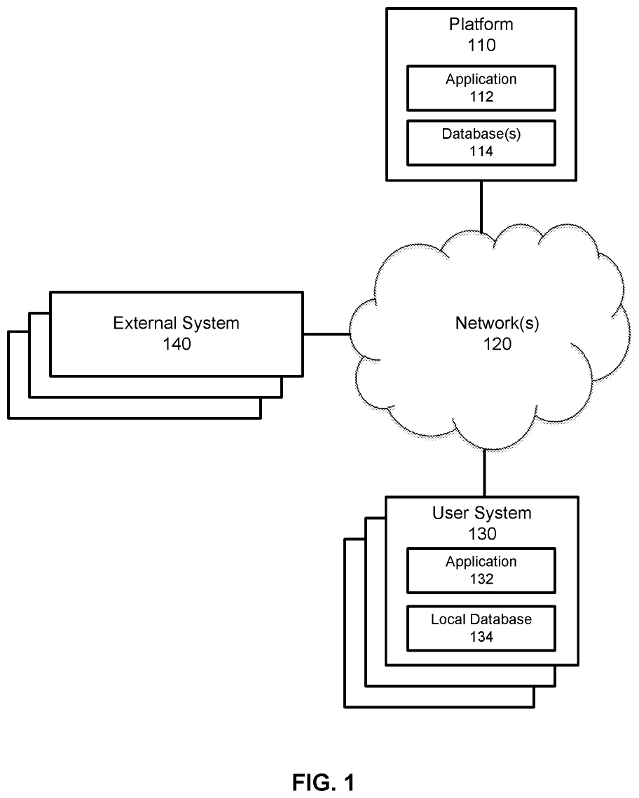

FIG. 1 illustrates an example infrastructure in which one or more of the disclosed processes may be implemented, according to an embodiment. The infrastructure may comprise a risk management and communications platform 110, e.g., one or more servers, which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to one or more server applications 112 and/or one or more databases 114. The server applications 112 include additional applications, some of which originate with external parties, and which have been integrated into platform 110 and made available via one or more application programming interface (API). In addition, platform 110 may be communicatively connected to one or more user systems 130 via one or more networks 120. Platform 110 may also be communicatively connected to one or more external systems 140, e.g., other platforms, websites, etc., via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134. Additionally, a user system 130 might also rely on an application or database external to the user which will be connected to the user system and/or external system via an application programming interface (API).

Platform 110 may comprise web servers which host one or more websites and/or web services. In embodiments in which a website is provided, the website may comprise a graphical user interface, including, for example, one or more screens, e.g., webpages, generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols, e.g., HTTP, HTTPS, etc. These screens, e.g., webpages, may comprise a combination of content and elements, such as text, images, videos, animations, references, e.g., hyperlinks), frames, inputs, e.g., textboxes, text areas, checkboxes, radio buttons, drop-down menus, buttons, forms, etc., scripts, e.g., JavaScript, and the like, including elements comprising or derived from data stored in one or more databases, e.g., database(s) 114, that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data, e.g., user data, form data, etc., to be stored in database(s) 114, and/or request access to data stored in database(s) 114. Any suitable database may be utilized, including without limitation My SQL™, Oracle™ IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module, e.g., comprised in server application 112, executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110, e.g., in which case server application 112 performs all processing, or user system(s) 130, e.g., in which case client application 132 performs all processing, or be distributed between platform 110 and user system(s) 130, e.g., in which case server application 112 and client application 132 both perform processing, or can comprise one or more executable software modules comprising instructions that implement one or more of the processes, methods, or functions described herein.

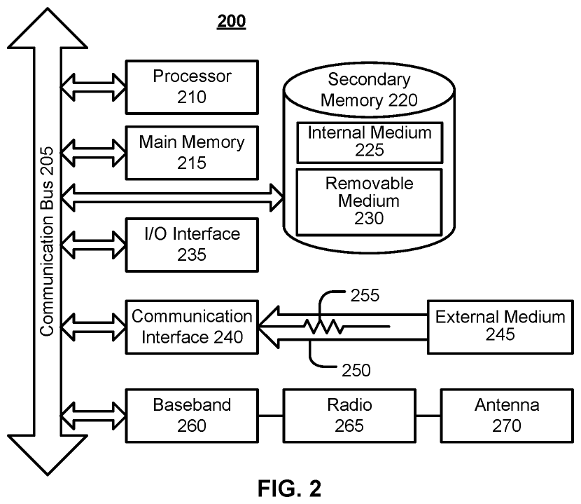

FIG. 2 is a block diagram illustrating an example wired or wireless system 200 that may be used in connection with various embodiments described herein. For example, system 200 may be used as or in conjunction with one or more of the functions, processes, or methods, e.g., to store and/or execute the software, described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms, e.g., digital-signal processor a slave processor subordinate to the main processing system, e.g., back-end processor, an additional microprocessor or controller for dual or multiple processor systems, and/or a coprocessor. Such auxiliary processors may be discrete processors or may be integrated with processor 210. Examples of processors which may be used with system 200 include, without limitation, any of the processors, e.g., Pentium™, Core i7™, Xeon™, etc., available from Intel Corporation of Santa Clara, California, any of the processors available from Advanced Micro Devices, Incorporated (AMD) of Santa Clara, California, any of the processors, e.g., A series, M series, etc., available from Apple Inc. of Cupertino, any of the processors, e.g., Exynos™, available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code, e.g., any of the software disclosed herein, and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like.

As mentioned above, system 200 may include a communication interface 240. Communication interface 240 allows software and data to be transferred between system 200 and external devices, e.g. printers, networks, or other information sources. For example, computer software or executable code may be transferred to system 200 from a network server, e.g., platform 110, via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network, e.g., network(s) 120, or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, e.g., network(s) 120, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code, e.g., computer programs, such as the disclosed software, is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225 and/or removable medium 230), external storage medium 245, and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display, e.g., in a smartphone, tablet, or other mobile device.

System 200 may also include optional wireless communication components that facilitate wireless communication over a voice network and/or a data network, e.g., in the case of user system 130. The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions, i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

Embodiments of processes for risk management will now be described in detail. It should be understood that the described processes may be embodied in one or more software modules that are executed by one or more hardware processors, e.g., processor 210), for example, as a software application, e.g., server application 112, client application 132, and/or a distributed application comprising both server application 112 and client application 132, which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component, e.g., general-purpose processor, integrated circuit (IC), application-specific integrated circuit (ASIC), digital signal processor (DSP), field-programmable gate array (FPGA) or other programmable logic device, discrete gate or transistor logic, etc., combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Platform 110 can be configured to operate a series of modules and functions that are interoperable, but may be acquired by a customer as separate services: 1. Risk management helps companies and their TPSPs identify, map, share documentation and information, analyze a range of data sources, manage, oversee and mitigate the risks of outsourcing to TPSPs and subcontractors, and maintain the foregoing on a current basis; 2. Incident management and business continuity help companies and their TPSPs to instantly communicate, share documentation and information, analyze a range of data sources, report to internal and external parties including counterparts and regulators, and proactively manage and mitigate the effects of service disruptions on the company and its customers; 3. Acknowledgement of notifications or communications can be delivered where a specific response is required, such as an amendment to contractual terms; and 4. Delivery of critical insights and proactive alerts derived from monitoring and data analysis or risk indicia against the background of regulatory requirements and best practices; and straightforward reporting tailored to targeted recipients.

The traditional method for outsourcing risk management involves a company making a decision to outsource and then conducting due diligence on a TPSP in a unidirectional approach between two counterparties. This may be viewed as a type of “top-down” approach from the outsourcing company to the TPSP, for which the outsourcing company does not necessarily need to collect and maintain data in a digital and structured form. The point of departure for the application of the embodiments described herein can be either the identification of one or more pre-existing outsourcing relationships, or the process of entering into a new relationship.

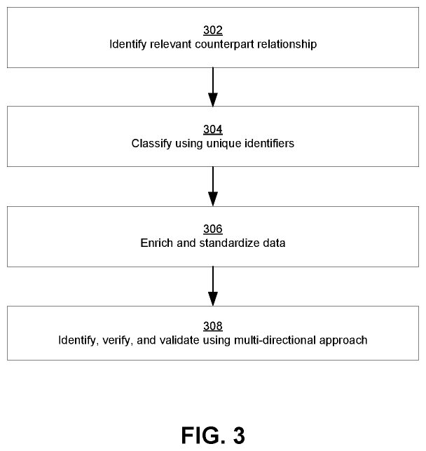

Platform 110 allows outsourcing risk management in a better way as illustrated by the flow chart of FIG. 3, which shows a structured process to maintain a current and correct overview of outsourcing relationships, which in turn would enable incident notifications and reporting.

In step 302, a relevant counterpart relationship is identified. Step 302 is initiated by the customer using the service (e.g., the customer identifies a relevant counterpart relationship). For the convenience of the customer, Platform 110 facilitates the entry of the name and relevant contact information of a customer relationship counterpart in multiple ways utilizing any of the means described in connection with FIG. 2 and, e.g., their user system 130 of FIG. 1, including by the customer directly typing the information in response to a prompt, by uploading a list of counterpart names in a spreadsheet or other common formats, or through an API interacting with another software or system used by the consumer to maintain relevant counterpart information. Note that the process of FIG. 3 is applied to every relevant counterpart relationship identified by the customer (e.g., for every entry in a provided list of counterpart names). In one example, a relevant counterpart relationship may be identified by a subcontractor or service provider of the platform customer (e.g., via interaction with the platform during the multi-directional identification, verification, and validation step 308, as will be described further in the disclosure).

FIG. 3 illustrates the process as applied to each individual relationship in a simplified way. The steps of FIG. 3 can be applied in an iterative process as more information is identified, corrected, or made more precise. In the event of multiple relationships entered into the platform 110 at the same time such as the upload of a list, the steps can be applied to each relationship in parallel, sequentially, or both, especially as iterative steps are applied.

In step 304, Platform 110 classifies individual companies and service providers on the basis of a unique legal entity identifier, including separate unique identifiers for different services lines that could have materially different risks characteristics such as potential for disruption and incident notification (“unique identifiers”).

Then, in step 306, the platform 110 performs standardizing and enriching of the information from any given party with additional data from public or commercial databases, and information provided by other customers and participants using the platform (“data enrichment”).

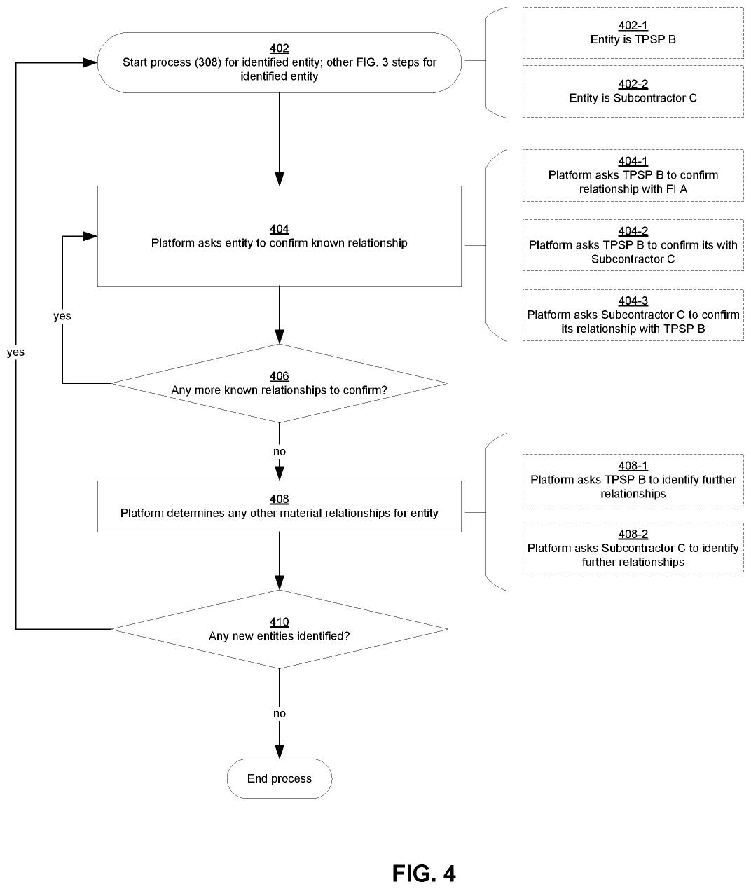

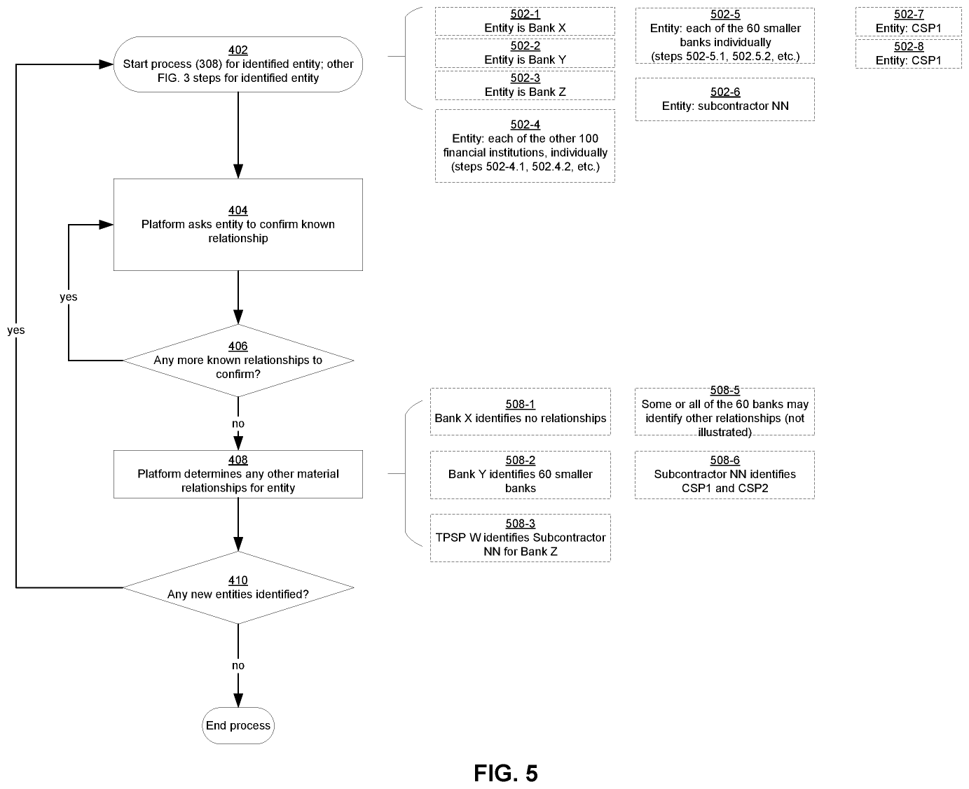

And in step 308, the platform 110 performs identifying, verifying, and validating of relationships in a multi-directional approach from the outsourcer to the TPSP and from the TPSP to the outsourcer (“multi-directional validation”). Two examples of step 308 are further illustrated in FIGS. 4 and 5, respectively. Platform 110 can assist the customer in its risk classification of the relationship through the analysis of data points added through the steps illustrated in FIG. 3, by applying default criteria derived and maintained in platform 110 from applicable regulatory requirements and industry best practices; under optional criteria chosen in advance by the customer and pre-figured in platform 110; or as chosen by the customer and entered into the platform along with the relationship identification; in the event of the latter option, the platform nonetheless may provide for a quality check on the basis of one or both of the former options.

The process of FIG. 3 improves upon existing practices and addresses some of the traditional challenges to outsourcing risk management, by (a) improving the preciseness of information related to counterparts; and (b) a significant improvement in the timeliness and maintenance of current, and possibly changing, information relevant to risk, especially as compared to traditional practices such as an annual status review by the outsourcer which also may have significant temporal and information gaps.

Referring to step 304, each legal entity for which there is information in the platform (regardless of status as an outsourcer, service provider, subcontractor, or multiple such roles) can be identified not only by common identifiers such as name and address, but also a unique legal entity identifier, for example the Global Legal Entity Identifier (GLEI), which is a 20-digit alphanumeric code based on an ISO standard 17442. In practice, and in the absence of universal adoption, many companies may have multiple legal entity identifiers that will be incorporated into the platform. For example, beyond the GLEI, an US financial institution generally will have an identification number assigned by its primary regulator, while vendors and other service providers are often identified in connection with the DUNS number classification of Dun and Bradstreet. Any entity not already having a generally accepted unique identifier will be assigned a unique identifier via platform 110. Additionally, separate unique identifiers may be assigned via platform 100 for different services lines of a single legal entity that could have materially different risks characteristics such as potential for disruption and incident notification. These innovations of the invention to uniquely identify entities and, in some cases, services are an improvement upon existing practices whereby a given company exercising a uni-directional approach in identifying its own service providers might find it sufficient to refer to a corporate group or branding that actually involves multiple different legal entities, service centers, or common branding association, e.g., “Microsoft,” “SAP,” or “KPMG”, notwithstanding that risk characteristics might differ for different sub-entity relationship, e.g., the local jurisdiction implementation instance, or service, e.g., licensing software installed on premise of the outsourcer versus a “cloud” version which entails different hosting or data management arrangements.

The unique identifier can serve as a basis to include within the platform, and continually update in the event of changes over time, material identifying information related to a legal entity. For example, this can include in the case of a financial institution identified in the U.S. Federal Financial Institutions Examination Council's National Information Center, the address, active status of the institution, relevant aspects of corporate hierarchy or relationships, and other identifying information; in other jurisdictions, similar information is available in a corporate register. Differentiation by service offerings can evolve as more users and services are included in the platform. An additional service offering, which might involve an additional fee to the customers, incorporates monitoring of external data services commonly referred to a “negative news” to help proactively identify material changes to relevant characteristics of a legal entity, such as in the context of mergers and acquisitions, bankruptcy or insolvency, or adverse regulatory actions such as the suspension of a license. Further identified or identifiable data elements may include determination of the significance or criticality of the relationship, as well as specific risk indicators such as in the context of financial services whether the relationship involves the transfer of personal data which might be subject to additional regulatory restrictions or risk management considerations.

Starting with the identification of the relationship in step 302, data points such as those exemplified in the preceding paragraph, are gleaned from customers, public or commercial databases, or data analysis applied across other entity information within the platform 110, in an iterative application of step 306 structure the data and content as related to a counterpart entity.

From the perspective of a new customer of the platform 110, or of an existing customer seeking to expand usage of the platform 110 for risk management with respect to a new outsourcing relationship entered in a further initiation of step 302, the processes illustrated in FIG. 3 create significant efficiencies through the pre-population of data with respect to a potential counterpart, minimizing manual errors or ambiguity, and maintaining current granular details. For example, assume that TPSP A has been identified as a counterpart to one or more customers of platform 110 and undergone the processes illustrated in FIG. 3. When a new customer to platform 110 initiates step 302 to identify TPSP A as a relationship, the new customer will benefit from enriched and structured data about TPSP A already present within platform 110.

The following two examples provide simplified versions of the multi-directional validation of information of step 308, from the perspective (i) first in FIG. 4 of the category of a company that is outsourcing, and (ii) second in FIG. 5 of a third party service provider. Each of the outsourcer and TPSP can be a customer and user of the platform. Note that in some factual cases, a legal entity might serve both as an outsourcer and a service provider, in which case the step 308 multi-directional validation of each of FIG. 4 and FIG. 5 would apply. The interrelation between the processes illustrated in FIG. 3 and those illustrated collectively in FIG. 4 and FIG. 5 can be understood as different dimensions, with FIG. 3 as described above platform 110 enriching, standardizing and validating data with respect to each individual entity, while FIG. 4 and FIG. 5 illustrate how the platform 110 involves each entity in the validation not only of its own and counterpart data but the most important aspect of these illustrations is the validations of relationships with other entities. The processes of FIG. 3 and collectively of FIG. 4 and FIG. 5 continually interact in iterative fashions.

First, FIG. 4 illustrates an example of the platform 110 performing the multi-directional validation process (step 308 of FIG. 3) for an outsourcing entity which for the purpose of this illustration is designated as Financial Institution (A or FI A). The identification of a relationship in step 302 also triggers the process here of step 402. In the example of FIG. 4, Financial Institution A identifies a relationship with a TPSP B, which Financial Institution A believes in turn relies on a further Subcontractor C. In other words, FI A identifies its own relationship to TPSP B and the relationship between TPSP B and Subcontractor C. Step 402 may include some or all of the steps 304-306 of FIG. 3

Thus, in step 402 platform 110 can be configured to uniquely identify TPSP B (perform step 304 of FIG. 3). This can include not only an identification of the legal entity and its unique identifier, but also the nature of the service offering, and the extent to which the outsourcer, in this case TPSP B, has identified the relationship as significant or critical for its operations. Thus, the processes illustrated in FIG. 3 are being applied to TPSP B in step 402 of FIG. 4. For the sake of simplification, this reference to the FIG. 3 processes will not be repeated for each entity mentioned in the examples of FIG. 4 and FIG. 5.

In step 404, the current identified entity is asked, through platform 110 and a user system 130 associated with the current entity to confirm a known (or previously identified) relationship. Individual iterations of step 404 are identified as 404-1, 404-2, and 404-3 in the specific example of FIG. 4. In step 404-1, the current entity (TPSP B) is asked to confirm its previously identified (by FI A) relationship to FI A. The confirmation (or denial of the relationship) is recorded by the platform 110.

In step 406, the platform 110 decides whether additional identified relationships need to be confirmed by the current entity (in this case, TPSP B). In the current example, the relationship between TPSP B and Subcontractor C still needs to be confirmed, so the process returns to step 404. In 404-2, the platform 110 asks TPSP B to confirm the further relationship with Subcontractor C as relevant to the services accruing to FI A.

In step 406 again, the platform 110 decides whether any more relationships need to be confirmed by the current entity. This time, there are no more relationships for TPSP B to confirm.

In step 408, TPSP B can be asked to identify any other material subcontracting relationships (e.g., relevant to TPSP B servicing of FI A). In the current example, Subcontractor C may be identified as a material relationship in step 408 (in iteration 408-1). Alternatively, Subcontractor C may not need to be identified by TPSP B, as it was earlier already identified by FI A.

In step 410, the platform 110 may determine whether any new (relevant) entities have been identified. In this case, Subcontractor C has been identified as a relevant entity via its relationship to TPSP B, so the answer is yes.

Thus, the process returns to step 402, this time with the entity being Subcontractor C. Note that if other subcontractors had been identified in step 408-1, the process of FIG. 4 would return to step 402 for each of the newly identified subcontractors, and the process of FIG. 4 would run (in parallel, in series, or a combination of the two) for each of the nearly identified contractors. However, for the sake of the current example, only Subcontractor C has been identified in step 408-1.

Back in step 402, the platform 110 can uniquely identify Subcontractor C (step 304) and perform other FIG. 3 functions for Subcontractor C, as well as initiate the process of step 308.

In step 404 (iteration 404-3), the current entity (Subcontractor C) is asked, e.g., through the platform 110 and user system 130, to confirm its relationship with TPSP B.

In step 406, the platform 110 decides whether Subcontractor C needs to confirm any other known/identified relationships. In this case, the answer is no, so the process moves onto step 408.

In step 408 (iteration 408-1), Subcontractor C is asked through, e.g., the platform 110 and user system 130, whether it materially relies on subcontracting relationships with respect to the relationship with TPSP B. If yes, the process would have continued (e.g., the answer to decision 410 would be yes, so the process would loop back to step 402 for each newly identified subcontractor). In the example of FIG. 4, however, the answer is no, which leads to the end of the initial population chain (the answer to decision 410 is no, so this the current chain of the multi-directional process ends).

As previously mentioned in the disclosure, various subprocesses, which do not depend on completion of other subprocesses, may be logically executed before, after, in parallel, or partially in parallel with other independent subprocesses. Thus, although the individual steps of FIG. 4 are illustrated in a particular order, the platform may perform these steps in different sequences or in parallel (as far as logically allowed). For example, repeating steps (e.g., 402, 404), insofar as they do not require the conclusion of other iterations of the step, may be performed in parallel.

FIG. 5 illustrates an example of the platform 110 performing the multi-directional validation process (step 308 in FIG. 3 and steps 402-410 in FIG. 4) for an entity which for the purpose of this illustration is designated as a service provider, TPSP W. The traditional top-down perspective of an outsourcing entity conducting due diligence on its service providers does not involve service provider validation as illustrated herein. The general steps of process of FIG. 5 correspond to the same general steps (402-410) shown in FIG. 4 and thus are given the same labels.

The identification of a relationship in step 302 by a service provider also triggers the process here of step 402 of the process. In the example of FIG. 5, a TPSP W (e.g., using the platform 110 and user system 130) can identify relationships with respect to a service it provides to, for example, 100 different financial institutions, including banks X, Y, and Z, of which Bank Z has migrated to a cloud version which includes additional subcontractors. In other words, step 302 (identification of an entity) is triggered with respect to the 100 different financial institutions.

In step 402, the platform 110 can perform the functions of FIG. 3 steps on each of the 100 financial institution customers of TPSP W (e.g., uniquely identify). Thus, the processes illustrated in FIG. 3 are being applied to each of the financial institution customers of TPSP W in step 402. For the sake of simplification, this reference to the FIG. 3 processes will not be repeated for each entity mentioned in connection with FIG. 5. For further simplification, this example will not detail the application of the process to 100 distinct bank customers of TPSP W, but will only illustrate the part of the process related to three banks under different factual circumstances, denoted as Bank X, Bank Y, and Bank Z. In practice, an analogous process would be applied to each identified bank customer. FIG. 5 shows (in a first column), that step 402 is performed separately on Bank X (step 502-1), Bank Y (step 502-2), Bank Z (step 503-3), and the rest of the 100 financial institutions (step 502-4, which is itself composed of individual process steps for each of the institutions).

With respect to Bank X: (i) in step 502-1, the platform performs FIG. 3 functions on Bank X and initiates the rest of the process; (ii) in step 404, the platform confirms relationships of Bank X. For example, Bank X can be asked, through the platform 110 and user system 130, to confirm the relationship with TPSP W; (iii) in step 406, the platform determines no other relationships need to be confirmed by Bank X; (iv) in step 508-1 (iteration of 408), the platform asks Bank X to identify further relationships. In the example of FIG. 5, no other relationships are identified by (and for) Bank X; (v) in step 410, since no new entities/relationships have been identified, the process chain ends for Bank X.

With respect to Bank Y; (i) in step 502-2, the platform 110 performs FIG. 3 functions on Bank Y; (ii) in step 404, Bank Y can be asked, through the platform 110 and user system 130, to confirm the relationship with TPSP W; (iii) in step 406, no other relationships need to be confirmed; (iv) in step 508-2, the platform asks Bank Y to identify further relationships. In the example of process 500, Bank Y further identifies that Bank Yin turn serves as a third party service provider for 60 smaller banks for which Bank Y provides correspondent banking services. In response, (iv) in step 410, the platform 110 determines that new entities (60 smaller bank customers) have been identified and returns to perform step 402 for each of the 60 entities (illustrated as steps 502-5 in the second column of FIG. 5).

With respect to Bank Z: (i) in step 502-3, Bank Z may be uniquely identified (and other FIG. 3 functions performed); (ii) in step 504, Bank Z is asked, through the platform 110 and user system 130, to confirm the relationship with TPSP W; (iii) in step 406, the platform determines that no other relationships need to be confirmed and moves on to (iv) step 508-3, where the platform determines other relevant Bank Z relationships. In the example of FIG. 5, no other relationship is identified by Bank Z, but TPSP W discloses through platform 110 and user system 130 an underlying Subcontractor NN for operating the cloud services. Thus, (v) in step 410, the platform determines that a new entity has actually been identified (Subcontractor NN), and initiates step 402 (502-6) for Subcontractor NN.

With respect to Subcontractor NN: (i) in step 502-6, the platform 110 can, among other functions, uniquely identify the Subcontractor NN of TPSP W for operating the cloud services provided to Bank Z; (ii) in step 404, Subcontractor NN is asked (e.g., through the platform 110 and user system 130) to confirm the relationship with TPSP W. Further, the platform can ask whether Subcontractor NN is aware of its services being provided for the benefit of Bank Z (which might not be the case). In step 408 (508-6), the platform also asks whether Subcontractor NN relies on further relevant subcontractors. In the example of FIG. 5, Subcontractor NN identifies through the platform and user system 130 that it relies on a primary cloud service provider CSP1, as well as a backup cloud service provider CSP2 in connection with the service relationship with TPSP W. Thus, the platform 110 initiates step 402 for both of the identified cloud service providers (step 502-7 for CSP1 and 502-8 for CSP2).

In step 404 (stemming from 502-7), CSP1 is asked, through the platform 110 and user system 130, to confirm its relationship with Subcontractor NN (which in turn services TPSP W). In a further step 408, CSP1 is asked to identify further relationships (e.g., its sub-outsourcing relationships).

Similarly, in step 404 (stemming from 502-8), CSP2 is asked through the platform 110 and user system 130 to confirm its relationship with Subcontractor NN (which in turn services TPSP W). In a further step 408, CSP2 is asked to identify further relationships.

Note that although this is not illustrated in the process of FIG. 5, if CPSP1 or CPSP2 were to identify a further sub-outsourcing relationship, the process would continue (e.g., by trying to uniquely identify each of the further sub-outsourcing entities, etc.). The process will only stop initiating validation steps when no further relationships are identified.

Further, as noted with respect to FIG. 4, the various subprocesses of FIG. 5 may be performed in different sequences than described, and may be performed fully or partially in parallel with other subprocesses. For example, the initiating steps 502-1, 502-2, 502-3 (and 502-4) may be performed in any order, in parallel with each other, or partially in parallel.

As these simplified and truncated examples indicate, unlike traditional unidirectional evaluation of risk in a bilateral outsourcing relationship, the invention provides that any entity identified, enriched and validated through the platform 110 has the potential for a significant multiplier effect in the quality and timeliness of information. Any given financial institution or service provider can be expected to have multiple relationships; this implies that any additional entity using the platform has an increased probability that one or more of its relationships have already been identified, enriched and validated through the platform. Attempts to enter inconsistent information with respect to a uniquely identified legal entity will be flagged for manual review, reconciliation, and correction. Not only does this process of validation serve as a benefit to new entrants, but the economies of scale grow in the favor of existing customers of the platform 110 being able to rely on current information. The economies of scale for a legal entity to maintain updated information relevant to its counterparts creates a further incentive which is reinforced through the platform.

The platform 110 will mitigate not only the risk of errors such as incomplete or ambiguous legal entity name but will incorporate, over time, machine learning processes, for example, through peer comparisons whereby a classification of a service inconsistent with that of other participants over time would be flagged for human review. For example, if all banks have classified a service provider of a “core” accounting system as critical to the respective bank, an entry by a new user to classify such service as non-critical would be queried to verify. A response might be that this was in error or, in other circumstances, if it were justified, for example, in the case of a legacy system that had been decommissioned but remained available for access to legacy data during the applicable retention period. Similar examples would apply across the structured data elements that are collected as described in FIG. 3.

The identification, verification, and validation of outsourcing relationships, together with ongoing monitoring and supported by the incentive of all customers and participants in the platform 110 to maintain current information, enables a reliable data source. This data source serves as a significant improvement over traditional practices whereby an outsourcing company identifies its TPSPs, usually in a simple list, such as on a spreadsheet, which might be reviewed on an annual basis, but also for which there is no ability to undertake peer correction. In comparison, the underlying data points of the platform 110 are continually updated in a mutually reinforcing way.

The platform 110 includes a functionality to visualize or “map” the high-quality data with respect to entities and their outsourcing relationships, from different perspectives, which includes sorting by data characteristics that are relevant determinants of risks. Some or all of the data gathered—using the processes described above in FIG. 3, and further validated in the processes described in FIG. 4 and FIG. 5—with respect to risk management functions of the platform 110 may be used to generate the risk maps described herein.

The types of risk maps that could be generated through the risk mapping functionality of platform 110 from the perspective of an outsourcing company include, for example, one or more of: (i) an overview of all outsourced relationships, including subcontracting chain; (ii) relationships identified as involving critical outsourcings; (iii) outsourcings involving subcontractor relationships; (iv) flagging of potential concentration risk, including in the context of sub-outsourcings; (v) outsourcings involving personally identifiable information/personal data; and/or (vi) outsourcings involving TPSPs in other jurisdictions from the outsourcing company.

Platform 110 analyzes the data also for the purpose of identifying and flagging a potential concentration-relevant risk or risks not necessarily known to the outsourcing entity or other involved parties. One example of such a scenario would be where an outsourcing financial institution relies upon a TPSP A for a service line, such as payment services, and TPSP B as a backup service provider. The risk mapping can help identify whether each of TPSP A and TPSP B rely on the same sub-outsourcer (or other critical dependency in the further subcontracting chain), which risks being a single point of failure in what otherwise was meant to provide business continuity alternatives (e.g., a disruption of TPSP A foresaw resorting to TPSP B). Such dependency would not likely be identified under traditional processes whereby each outsourcing relationship may be reviewed independently.

The risk mapping functionality of the platform 110 also enables the outsourcing company to query the database and generate a risk map from perspectives other than a top-down approach. For example, a risk map may include an overview of all outsourcing relationships and chains that rely on a single subcontractor, such as a particular cloud provider. The risk map would make apparent the entities and services that could be expected to be impacted by a disruption of services from that single subcontractor.

The types of risk maps that could be generated through the risk mapping functionality of platform 110 from the perspective of a service provider include, for example, one or more of: (i) an overview of all service relationships; (ii) an overview of service relationships which in turn act as service providers to other entities (for example, where this could imply regulatory requirements, such as where the outsourcing company is a regulated financial institution); and/or (iii) an overview of subcontractor relationships (including aspects identified above, through the entire subcontractor chain).

The risk mapping functionality of the platform 110 allows not only the generation of outputs or reports, which may (i) be used for reporting to an executive team or a regulator (including, for example, if exported, a converted spreadsheet list, a PDF visualization, etc., which are enabled by platform 110) and/or (ii) enable dynamic exploration of potential risks and underlying data. With respect to the latter, users of the platform 110 may navigate through the network of the risk map via the user system 130, for example, by clicking on individual entities to zoom in and view the underlying risk-relevant characteristics. While the use of mapping software can enable multi-dimensional analysis, this drill-down functionality can be additionally useful for risk maps showing multiple outsourcing relationships.

In addition to the risk mapping viewpoints for an individual outsourcer or service provider, the platform 110 can enable generation of risk maps across multiple legal entities. A holding company may be interested in this functionality when reviewing possible risk correlations across multiple subsidiaries. Moreover, understanding concentration risks across industry participants is an area of particular interest and concern for government authorities responsible for critical infrastructure, financial stability and financial institution oversight. Subject to appropriate legal authority and consistent with confidentiality considerations of commercially sensitive information, the platform 110 anticipates the ability to generate risk maps for authorized oversight authorities.

A further innovation of the invention is the increased reliability of the data through the processes of validation and ongoing updates, based on the processes described in connection with FIG. 3 and collectively FIG. 4 and FIG. 5. The output though a risk mapping review of any level of data in the platform 110 are valuable even if all relationships have not been entered or fully validated; additional data and application of the validation process further increases the value of the platform 110.

The invention further provides a communications platform (including, for example, communications systems/functions of the platform 110) for efficient sharing of information and documents regarding: (A) risk relevant information and/or (B) incident notifications with respect to identified outsourcing relationships. The communications platform functions may be part of the risk management and communications platform 110. In one example, the communications and risk management functions of the platform 110 are controlled/managed by the same system(s) and processor(s). In another example, separate communications and risk management functions of the platform 110 may have their own separate systems, processors, servers, etc. The communication functions of the platform 110 may utilize the user system(s) 130 described above with respect to FIG. 1. For simplicity, the following paragraphs describing the communications platform will refer to is as part of platform 110.

The features of the communications platform 110 include: (i) recordkeeping and audit trail(s); (ii) “one-to-many” efficiencies, while preserving the ability to view and to maintain the confidentiality of bilateral information flow; and/or (iii) a focus on corporate to corporate communications through the minimization of personal data related to authorized users which are identified and authorized by the customer/user of the platform 110 consistent with such company's workflows and decision making criteria (e.g., the platform can incorporate alternatives of either a single authorized user initiating a communication to a counterpart, or a “four-eyes principle” process whereby one authorized user prepares a communication but the communication is only released to a counterpart upon approval by a second authorized user or supervisor).

While potentially sensitive data and documentation is maintained within the secure platform 110, the platform system(s) can also enable the generation of one or more messages/notifications outside the platform 110 to either a user system 130 or external system 140 to indicate the availability of new communications (e.g., an email to the normal company address of an authorized user directing the user to log in to the platform to retrieve new information) or to generate encrypted delivery to a party outside the platform.

In addition to meeting evidentiary requirements that required communications have been delivered, the platform 110 can incorporate, for example, an optional element which would allow acknowledgement and confirmation (e.g., in the context of a bilateral agreement to amend contractual terms). This may be accomplished either through a functionality within platform 110 or the integration via API of an external service such as with respect to digital signatures.

The platform 110 can enable an outsourcing company to request, and a TPSP to provide, information and documentation relevant to due diligence and risk evaluation. In some examples, this may include information and/or documentation regarding (i) corporate structure, ownership, licensing, and/or reputation of, for example, a service provider; (ii) size, financial strength, and/or insurance coverage; (iii) operational controls and service history; and/or (iv) due diligence questionnaires and responses which address many of the foregoing topics. Although there is no universally accepted process and standardized list of responsive documentation, the platform can serve to simplify the bilateral process between outsourcer and TPSP by categorizing the requests coming from an outsourcer as well as the most commonly provided responses by a TPSP. For example, an outsourcer might request that each service provider make available the following four items: (i) copy of license; (ii) description of ownership structure; (iii) audited financial statements; and (iv) a system and controls report. The platform 110 maintains on behalf of a customer who is a service provider these and other relevant due diligence information and documentation which need only once to be uploaded to the platform 110. The platform 110 facilitates a streamlined delivery of this documentation by making it available to the outsourcing company as a validated counterpart of the service provider. In another example, an outsourcer might request only the foregoing items: (i), (ii), and (iv). Using the same previously uploaded data, the platform 110 facilitates making this information available to the second outsourcing company.

In the event of a disruption of services, in the context of contractual requirements or additionally under regulatory requirements such as in the financial services industry, a service provider will be expected or required to provide an outsourcer with prompt notice of service outage or disruptions, often in connection with a materiality or time threshold set forth in a service level agreement or in a regulatory requirement.

In addition to enabling a service provider to report incidents of which it becomes aware, the platform 110 can provide an option for incorporating monitoring of third party data sources, for example, aspects of negative news. An output of such monitoring and data analysis is an analogous notice generated by the platform, in order to proactively raise awareness of a potential incident or vulnerability prior to a specific notice being delivered by a relationship, such as the TPSP described in the preceding paragraph and elaborated in the following paragraphs. Because of the similarity of the process other than the initial step, the process of delivery of a notice from monitoring will be illustrated separately.

With respect to above categories of communications related to incidents and notices, the platform 110 provides: (i) recordkeeping and audit trail(s); (ii) “one-to-many” efficiencies; and/or (iii) focus on corporate to corporate communications. These communications functionalities of the platform are explored in further detail below.

Regarding recordkeeping and audit trail(s), the platform 110 can maintain communications for a minimum period consistent with general recordkeeping requirements, to allow each of the sending and receiving party to rely on the platform as an authentic record of authorized communications showing time and date stamp, and unable to be altered unilaterally by one of the parties. This may enable a user of the platform to demonstrate the effectiveness of the communications systems to stakeholders, auditors, and regulators. As described in greater detail below, such recordkeeping and audit trail(s) can be produced on a bilateral basis even in situations where a sender is taking advantage of the platform's efficiencies in generating a similar content message delivered to multiple recipients.

Regarding “one-to-many” efficiencies, while preserving the ability to view and maintain the confidentiality of bilateral information flow—the following examples illustrate the improvements over traditional means of bilateral communications between counterparts using the platform. In a first example of “one-to-many” efficiencies, with respect to risk relevant information, the platform can enable an outsourcer to (i) initiate requests to all or any subset of its TPSPs with respect to a particular class of document (e.g., a request for evidence of insurance), (ii) send the received documents to all such designated TPSPs, (iii) track responses, and (iv) generate automatic reminder notices. From the perspective of each receiving TPSP, the incoming message may appear as a single bilateral communication. Follow-up may be pursued via the platform (i) in a bilateral form of a distinct communication from the outsourcer to the TPSP or vice-versa or (ii) in other multilateral communications which again appear as a bilateral message to the recipient.

In a second example of “one-to-many” efficiencies, from the perspective of a TPSP and with respect to risk relevant information, the platform can enable a TPSP to distribute a particular class of document (e.g., an updated business continuity plan) to all or any subset of outsourcing companies. From the perspective of each receiving outsourcing company the message may appear as a single bilateral communication. Follow-up may be pursued via the platform (i) in a bilateral form or (ii) in other multilateral communications appearing as a bilateral message to the recipient.

The following, third example of “one-to-many” efficiencies of the platform 110 illustrates improvements of the presently disclosed platform over existing bilateral communications with respect to incident notifications. Through the identified and validated relationships illustrated in FIG. 3 and the multi-directional validation processes of FIG. 4 and FIG. 5, the platform can maintain current communications channels for ready implementation of incident notification. This is a significant improvement over common practices whereby communications contacts might be identified in contractual documentation, but where contacts are not readily available, for example, (i) because a search through documentation is required to obtain the contacts, or (ii) in the event of change of contact persons, relevant updates have not been made, thus leading to delays to gather contact information once an incident occurs. Because a disruption even is by definition a low probability, unexpected, and/or unanticipated event, there is a cost-benefit challenge for an individual company to maintain current contact information for all of its relationship counterparts. The platform 110 innovations help solve this challenge.

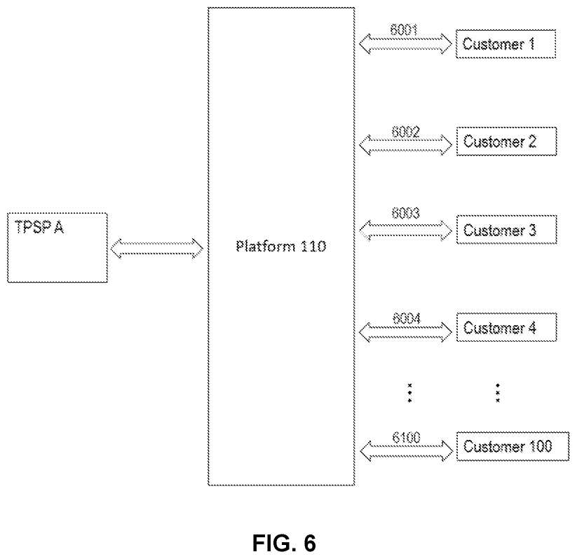

In the present example, shown in FIG. 6, TPSP A can provide a specific and substantially similar service to 100 financial institution customers (customers 1-100). When a disruption occurs that will negatively impact availability to all 100 customers (e.g., an information security incident requires TPSP to temporarily shut down the service, or a planned software upgrade does not function as intended and thus required a delay in reverting to the earlier software version), the disruption may trigger either a contractual or regulatory obligation to notify all 100 customer outsourcing companies.

The communications system/platform 110 can initiate a single common message about the disruption communicated through secure channels (6001, 6002 . . . 6100) of the platform and ensure availability to authorized recipients at all designated outsourcing companies. Each recipient company (customers 1-100) receives this communication as if it were a bilateral message in the sense that the recipient only receives indication of possibly confidential information relevant to its own situation.

If for example, upon review, TPSP A determines that (i) operations have resumed normally with respect to 97 customers (e.g., customers 4-100) but (ii) further investigation is required with respect to 3 customers (e.g., customers 1-3), for example, if any data was lost or compromised in connection with the incident, TPSP A can use the platform 110 to communicate the appropriate information to each of its one hundred customers. For the current example, TPSP A can, via the platform 110, (i) initiate a single service resumption message to customers 4 through 100, using individual communications channels (6004, 6005 . . . 6100), each of which may receive this as if were a bilateral message, and (ii) either initiate a different message instantaneously to the remaining three (customers 1-3) or, alternatively, initiate unique messages to one or more of the remaining three (using channels 6001, 6002, 6003). At any point, any of the 100 customer companies can engage in bilateral communications through the platform 110 (via channels 6001 . . . 6100), which are only viewable with TPSP A as counterpart.

Regarding a focus on corporate to corporate communications, as part of the administration of the platform 110, the platform system may require each customer/user (regardless of whether it is an outsourcing company or a service provider) to identify authorized individual users with respect to different functionalities of the platform (e.g., there might be different users for the communication of risk relevant information as compared to incident notifications). An innovative feature of the platform 110 concerns identification and authentication of authorized users initiating and receiving communications via the platform. For example, a text of the communication itself can identify the sending legal entity but will, as a default, pseudonymize the message to not include the personal identification data of the sending representative. In a further example, via platform 110, an authorized person from company/legal entity A may send a communication to company/legal entity B while (i) knowing that the message will be directed to the correct person or persons within company B and (ii) without knowing who that correct person or persons are (e.g., without having to know their names or contact information). The receiving user(s) of the platform at company B will receive this communication as a legitimate communication of company A, without receiving any information personally identifying the sender. In an example, the communication may identify, to the receiving person, a specific department of the company/legal entity or other pertinent information (e.g., a project reference number), without identifying the sender. The platform 110 can (i) verify that the sender is authorized to send the communication on behalf of their company (and, for example, on behalf of a specific department within the company), (ii) identify the people authorized to receive this communication (for example, based on the category of communication, a department/project identified by the sender, etc.), (iii) strip personal sender information from the communication, and (iv) provide the communication to the correct recipients. Such minimization of personal identifying data may (i) serve to reinforce the understanding of the communication as an authorized message on behalf of the legal entity and (ii) take into consideration evolving expectations for the minimization or requirement to be able to delete personal data such as under the European Union's General Data Protection Regulation (GDPR) or analogous personal data privacy requirements. The (i) pseudonymization of the message, and (ii) default of distinguishing the relevant message content from personal data regarding authorizing users, facilitate maintaining unaltered corporate records without risking contrary or potentially inconsistent personal data minimization or deletion obligations.

The platform 110 is configured to be able to meet incident notification obligations from a TPSP to an outsourcing company, including flexibility to accommodate different contractual or regulatory reporting conditions (e.g., disruption exceeding a minimum time period and automated calendar for update communications or reminders). In one example, one or more other applications may be able to use the platform as an alternative or backup incident notification system. This may be particularly useful for a TPSP that already intends to communicate disruptions or incidents to its customers through its own service platform (e.g., in connection with a dashboard or service monitor), if such reporting functionality is unavailable to the TPSP (e.g., in the event of a total outage of access to the service). Thus, the platform may be used to timely meet contractual or regulatory incident reporting obligations, including as a parallel or backup, business continuity incident reporting and communications service.

Various innovations of the platform 110, including structuring of data, validation and ongoing updates through the processes illustrated in FIG. 3 and FIG. 4 and FIG. 5, enable outsourcing companies and their TPSPs to more quickly and efficiently identify and communicate potential risk events. Secure communications to pre-validated company contacts may avoid risks of human error or lost-time when a low probability event occurs, such as in traditional practices whereby only after an incident occurs might the search for appropriate contact persons commence. The time savings is particularly important due to the increasing reliance on TPSPs and opportunity costs of system downtimes in an increasingly digital world, and in light of strict timelines for reporting requirements under contractual agreements and/or regulatory requirements. Furthermore, the savings in administrative efforts (e.g., in the event of an incident) facilitated by the platform may be better invested in incident remediation, thereby improving the risk management and recovery of an organization using the platform.

In addition to meeting evidentiary requirements that required communications have been delivered, the platform 110 can incorporate an optional element which would allow acknowledgement and confirmation, for example, in the context of a bilateral agreement to amend contractual terms. This functionality of the platform 110 solves a frequent challenge among outsourcing companies and TPSPs by which unidirectional communications systems do not lead to a response or involve contacting individuals not authorized to bind their employer companies, thus exposing the companies to gaps or ambiguity in the ability to enforce relevant contractual aspects of a service relationship. Incorporating this functionality within the validated and secure communications system of the platform 110 vastly improves upon common industry practices of bilateral follow-up resorting to a separate communications process. One example of a common practice involves a TPSP providing notices to the outsourcing counterparty under an agreed communications channel. However, if the communication requires a contractually binding acknowledgement, such communication would be printed out as a document, referred to an authorized signatory, countersigned, and returned by scanning and emailing an electronic version with an original sent by postal mail. The acknowledgement and confirmation functionality of the platform 110 can greatly simplify, speed up, and otherwise improve this process.

The various functionalities of the platform 110 can also enable customers to fulfill reporting requirements to regulators or other public authorities, such as with respect to classes of disruption incidents or information breach, for example (i) reporting a breach of personally identifiable data to U.S. Federal or State authorities or, within the European Union, to data protection authorities under the GDPR and (ii) reporting computer security incidents to the U.S. Federal Banking Agencies under the regulations going into effect in 2022 or analogous incident reporting requirements under consultation in the European Union under the proposed Digital Operations Resilience Act. As described in greater detail below, the platform 110 is configured to meet reporting requirements as they evolve.

For example, the platform can maintain summary information and links to relevant reporting requirements as a resource available to customers/users in complement to other business continuity efforts. This provides value because when a low probability incident occurs, there is little time to both begin educating oneself about the implications and meet time-sensitive reporting obligations.

The unique identifying information collected, validated and maintained by the platform 110, through the processes illustrated in FIG. 3 and in FIG. 4 and FIG. 5 with respect to customers (or for customers and service providers, based upon the customers or ultimate consumers they serve, which might trigger reporting obligations) can include information regarding licenses as well as indications of jurisdictions served. These data points in turn allow the platform system to identify default presumptions of reporting obligations.

In the event of an incident, various templates for incident notification communications, available to the customer through the platform 110, can reflect categories and classifications of incidents which likely trigger reporting requirements. The platform 110 can also generate additional prompts to the involved customer to obtain additional information, such as thresholds that might be relevant to identifying or determining reporting requirements. The platform 110 can also generate a suggestion to the customer that action should be taken to report, based on one or more of the input elements of (i) one or more specific reporting requirements, (ii) the characteristics of the entity making it likely subject to such reporting, and (iii) the specific facts of the incident.

The platform 110 system can pre-populate the reporting form(s) consistent with regulatory requirements or industry best practices, including, for example (i) fields relating to the identification of the reporting entity including the unique legal entity identifier used by such authority and/or (ii) relevant factual information related to the incident.

The platform 110 can also directly file the report, and maintain records consistent for audit trails and regulatory requirements, if agreed by the customer and allowable by the receiving authority. For example, in many instances, a regulatory must specifically authorize a third party, such as one providing the platform 110, to deliver incident reports on behalf of an entity subject to reporting requirements.

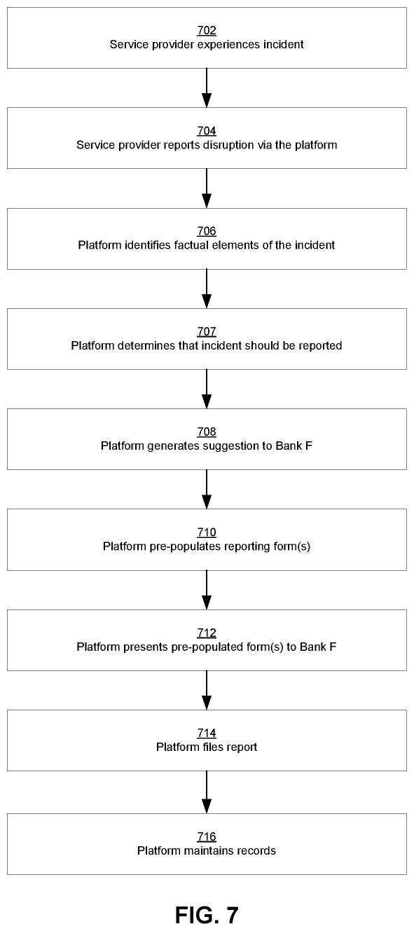

FIG. 7 illustrates an example of the platform 110 providing the functionality of facilitating reporting of an incident.

In the example of FIG. 7, Bank F is a state chartered financial institution, subject to oversight by the Federal Deposit Insurance Corporation (FDIC). Bank F uses TPSP N for managing its consumer facing web interface, which is a reportable outsourcing under the banking regulation. Further, upon becoming a customer of the platform 110, Bank F obtained approval from the FDIC for the platform 110 to report incidents to the FDIC on behalf of Bank F. In step 702, TPSP N experiences an operational disruption with its service. In step 704, TPSP N utilizes the platform 110 incident-reporting services to report the incident to Bank F, which incident may continue for a period of over two days, thus triggering threshold requirements for Bank F to report to the FDIC (step 706, explained below).

The execution of reporting functions of the platform 110 works as follows (steps 706-714 of FIG. 7). The platform 110 can maintain summary information and links to the incident reporting requirements of the FDIC. The platform system can also pre-identify (i) that Bank F is subject to these FDIC reporting requirements and (ii) that the outsourcing to TPSP N has been identified as a critical outsourcing for the purposes of FDIC regulation.

In step 706, the system of the platform 110 identifies factual elements through the communication of the incident reporting from TPSP N to Bank F, including that the incident has not been reported as resolved within applicable time thresholds.

In step 707, the platform 110 determines that an action should be taken (e.g., that the incident should be reported). The determination is based on one or more of the input elements: (i) specific reporting requirements (pre-determined by the platform for the relationship between Bank F and the FDIC), (ii) characteristics of the entity (pre-determined by the platform for Bank F), and (iii) facts of the incident (gathered in step 706).

In step 708, the platform 110 generates a suggestion to Bank F that, based on some or all of the foregoing input elements, this is a reportable incident to the FDIC as regulator of Bank F.

In step 710, the platform 110 pre-populates the reporting form(s) on behalf of Bank F including reporting template fields relating to the identification of Bank F and the relevant factual information related to the incident drawn from the incident reporting communications from TPSP N to Bank F (of step 704).

In step 712, this pre-populated report is presented to an authorized representative of Bank F designated in advance by Bank F for this purpose, using the platform 110 and user systems 130, for approval.

In step 714, once approval has been received from the authorized representative, the platform 110 files the approved report from Bank F to the FDIC.

In step 716, the platform 110 maintains records consistent for audit trails and regulatory requirements.

In the foregoing illustration, the reporting has been successfully completed by the platform 110 in accordance with regulatory requirements, ensuring the quality of the data reported, while massively decreasing the administrative effort for Bank F, as compared to if Bank F were to attempt to meet its incident reporting requirements without utilizing the services of platform 110. A user of platform 110 can still benefit from these innovations of the invention if it does not utilize the full scope of the process set out in FIG. 7, for example, if a reporting obligation had been identified independent of the platform in step 707, or if the user were to file a report not using step 714 of the platform.”

While some existing services may provide connection and transfer of required reports to government portals for the delivery of required reports equivalent to the digital movement of what previously might have been a document signed and mailed through a postal service, the disclosed functionalities of the platform 110 can allow for reporting to be a direct output of the operational risk management systems, methods and validations, to facilitate identification of reporting obligations of which an entity might not even timely be aware, and to fulfill such reporting obligations with greater speed and accuracy, and in fulfillment of regulatory reporting and recordkeeping obligations, within one central platform.

Finally, the platform 110 can (i) track relevant aspects of usage of the functionalities of the platform system, (ii) conduct data analysis and (iii) provide reporting of relevant performance indicators. These may include rates of responsiveness to each category of communications related to risk information as well as incidents and trends over time related to the effectiveness of risk mitigation efforts. Reporting may be subject to minimum data requirements to ensure each of statistical significance and sufficient diversity of input entities to allow anonymization.

This information may be made available to a platform customer relevant to addressing its own performance and that of its counterparts (e.g., for inclusion in an annual report on operational risk management efforts); for the evaluation of counterparts, including in a peer comparison format; and, to the extent legally permissible and subject to relevant jurisdiction to supervisory authorities, to provide the customer oversight of risk mitigation efforts throughout the supervised industry sector.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method of providing a risk overview for an outsourcing company comprising using at least one hardware processor to:
obtain outsourcing relationship data of the outsourcing company, the outsourcing relationship data including (i) identification of one or more service provider entities that provide services that directly or indirectly affect the outsourcing company and (ii) identification of relevant outsourcing relationships of each of the one or more service provider entities;
identify one or more areas of interest in the relationship data; and
generate a visual representation of the relationship data, including flagging the one or more areas of interest.

2. The method of claim 1, wherein obtaining the outsourcing relationship data comprises: obtaining at least partially multi-directionally validated data.

3. The method of claim 2, wherein the at least partially multi-directionally validated data comprises relationship information that has been confirmed by at least two parties.

4. The method of claim 1, wherein identifying the one or more areas of interest comprises identifying critical relationships of the relevant outsourcing relationships.

5. The method of claim 1, wherein identifying the one or more areas of interest comprises identifying sub-contracting entities of the one or more service provider entities, wherein the sub-contracting entities (i) do not provide services directly to the outsourcing company and (ii) do provide a service to at least one other of the one or more service providers that is relevant to the outsourcing company.

6. The method of claim 1, wherein identifying the one or more areas of interest comprises identifying one or more potential concentrations of risk within the outsourcing relationship data.

7. The method of claim 6, wherein the one or more potential concentrations of risk comprises: one or more sub-contractors of the one or more service provider entities that provides services to two or more of the one or more service provider entities.

8. The method of claim 6, wherein the one or more potential concentrations of risk comprises: a multiply-used entity of the one or more service provider entities, wherein the multiply-used entity provides relevant services (i) directly to two or more others of the one or more service provider entities or (ii) directly to one other of the one or more service provider entities and the outsourcing company.

9. The method of claim 1, wherein identifying the one or more areas of interest comprises identifying security-critical relationships of the relevant outsourcing relationships, wherein the security-critical relationships comprise at least storage or transfer of sensitive information.

10. The method of claim 9, wherein the sensitive information comprises one or more of: personally identifiable information or financial data.

11. The method of claim 1, wherein identifying the one or more areas of interest comprises identifying one or more entities of the one or more service provider entities that least partially operate in multiple regulatory jurisdictions.

12. The method of claim 11, wherein the multiple regulatory jurisdictions comprise multiple states.

13. The method of claim 1, wherein identifying the one or more areas of interest comprises identifying one or more entities of the one or more service provider entities that least partially operate in a regulatory jurisdiction that is different from a regulatory jurisdiction of the outsourcing company.

14. The method of claim 1, further comprising using the at least one hardware processor to: periodically update the outsourcing relationship data; and generate new visual representations of the relationship data.

15. The method of claim 14, wherein periodically updating comprises at least one of: monitoring one or more databases, periodically querying the one or more entities, or periodically querying the outsourcing company.

16. The method of claim 1, further comprising using the at least one hardware processor to: display the visual representation of the relationship data via a graphic user interface connected to the at least one hardware processor; detect user inputs via the graphic user interface; and in response to the user inputs, modify the visual representation.

17. A non-transitory computer-readable medium having instructions stored therein, wherein the instructions, when executed by a processor, cause the processor to:
obtain outsourcing relationship data including identification relationships between two or more of a plurality of connected entities, wherein at least a portion of the relationships are multi-directionally validated;
obtain a selection of at least one of (i) a type of risk evaluation, (ii) an entity of the plurality of connected entities, and (iii) an area of interest; and
based on the selection, generate a visual representation of the outsourcing relationship data.

18. The non-transitory computer-readable medium of claim 17, wherein at least one of the plurality of connected entities comprises a first service provider, the selection comprises a selection of the first service provider, and the visual representation comprises one of (i) an overview of all outsourcing relationships of the first service provider and (ii) an overview of all subcontractor relationships of the first service provider.

19. The non-transitory computer-readable medium of claim 17, wherein the selection comprises a selection of an area of interest, the area of interest comprising potential cross-jurisdictional relationships of any of the plurality of connected entities.

20. The non-transitory computer-readable medium of claim 17, wherein at least another portion of the relationships are not multi-directionally validated and wherein the visual representation differentiates between the multi-directionally validated and not multi-directionally validated relationships.

21. The non-transitory computer-readable medium of claim 17, wherein the instructions, when executed by the processor, further cause the processor to: periodically update the outsourcing relationship data.

22. The non-transitory computer-readable medium of claim 17, further comprising a communications and risk management system connected to the processor, wherein obtaining the outsourcing relationship data comprises using at least the communications and risk management system to (i) communicate with each of the connected entities, (ii) evaluate each of the connected entities, individually and with respect to others of the connected entities, and (iii) monitor each of the connected entities for incidents, and wherein the instructions, when executed by the processor, further cause the processor to: obtain system usage information; perform one or more analyses of the system usage information; and generate performance indicators based on the one or more analyses.

23. The non-transitory computer-readable medium of claim 22, wherein the system usage information comprises one or more of: rates of responsiveness of the connected entities to communications within various categories of communication; rates of responsiveness of individual ones of the connected entities; incident rates; and changes to one or more rates over time.

24. The non-transitory computer-readable medium of claim 22, wherein the instructions, when executed by the processor, further cause the processor to: determine that a performance indicator meets a predetermined threshold of risk; and based on the determination, generate a visual representation of the system usage information, including the performance indicator.
